(19) United States
(12) Patent Application Publication
(10) Pub. No.: US 2009/0063755 A1
(43) Pub. Date: Mar. 5, 2009

(54) PAPER-SHAPED NON-VOLATILE STORAGE DEVICE

(75) Inventors: Nei-chiung Perng, Taipei City (TW); Chih-jung Lin, Taoyuan City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/138,880

(22) Filed: Jun. 13, 2008

(30) Foreign Application Priority Data
Sep. 4, 2007 (TW) 096214818

(51) Int. Cl. G06F 12/00

(52) U.S. Cl. 711/100; 711/E12.001

(57) ABSTRACT

A paper-shaped non-volatile storage device includes a top paper layer, a bottom paper layer and a flexible printed circuit board packaged between the top paper layer and the bottom paper layer. The flexible printed circuit board comprises a data-transmitting interface, a non-volatile memory controller and at least one non-volatile memory disposed thereon. Therefore, the paper-shaped non-volatile storage device features as both of traditional paper and traditional non-volatile storage devices, such as instantly writing, manually binding, and outwardly visible content as provided by the traditional paper sheets, and digital information storage, repeatable editing and rapid search capability as provided by the traditional non-volatile storage devices.

### BACKGROUND OF THE INVENTION

1. Field of the Invention

The present invention generally relates to a non-volatile storage device, and particularly relates to a non-volatile storage device having a non-volatile memory packaged by paper layers.

2. Description of Prior Art

A non-volatile memory (NVM) features data retention under power off, differently from a volatile memory losing data retention under power off. Besides, the non-volatile memory also features smaller volume, low power consumption and high capacity storage and is therefore widely used for various types of electrical systems, such as personal computers, cellular phones, digital cameras, MP3 audio players, and so on. Examples of non-volatile memory include magnetic media for tremendous data storage such as hard disks and magnetic tapes, optical media for data exchange such as compact discs (CDs) and digital video discs (DVDs), and popular flash memory for consumer electronics such as flash memory cards and USB flash drives. Most of these storage devices have very small volumes and are capable of efficiently storing a large amount of digital data thereon.

Nowadays, a flash memory is one of the most popular non-volatile storage devices due to the great benefit in proportioning a usable storage capacity to a spent cost. For example, a well-known Secure Digital (SD) card employs the flash memory as its storage media so as to a high capacity storage and space saving. As illustrated at FIGS. 1 and 2, a traditional SD card is mostly constructed of a top cover 210, a bottom cover 230 and a circuit board 220 packaged between the top and bottom covers 210 and 230, respectively. The circuit board 220 comprises a plurality of contact pins 221, a memory controller 222 and at least one memory chip 223 disposed thereon. However, to access data of the SD card, a user has to employ a corresponding additional card reader and/or a driver (with a personal computer) which have a higher element cost than traditional paper sheets to read or write information. Furthermore, the SD card lacks a convenience on forthrightly handwriting and outward visibility to/from a paper sheet, especially for a manual collation of existing folders in paper. For types of which some data are suitable/need to record by handwriting in a paper sheet, the SD card is uncertainly qualified.

On the other hand, each traditional A4-sized paper sheet merely provides a limited writable capacity of only about 1200 words and a redundant word-searching operation. Although bring a convenience on forthrightly handwriting, binding and a manual folder collation, the traditional paper sheet causes data storage and search inefficient, inconvenient and redundant. For example, a 2 GB SD card can store as much information as 80,000 sheets of A4-sized papers do so as to save great spaces as occupied by those paper sheets, and provides a multi-rewritable and searchable capability.

Therefore, it is essential to create an innovative storage device for simultaneously satisfying requirements of multi-rewritable memory capacity, rapidly searchable capability, forthrightly handwriting, binding, and manual folder collation.

### SUMMARY OF THE INVENTION

To eliminate the forgoing drawbacks, a primary object of the present invention is to provide a paper-shaped non-volatile storage device, which features consisting of multi-rewritable memory storage, rapidly searchable capability, forthrightly handwriting, binding, and manual folder collation, as provide by both the traditional paper sheets and the traditional non-volatile memory devices.

A paper-shaped non-volatile storage device in accordance with the present invention comprises: a top paper layer, a bottom paper layer and a flexible printed circuit board (PCB) packaged between the top paper layer and the bottom paper layer. The flexible PCB comprises a data-transmitting interface, a non-volatile memory controller and at least one non-volatile memory disposed thereon.

Differently from the traditional paper sheets, the paper-shaped non-volatile storage device is reusable to store digital information and the digital information is retrievable even if the paper package of the device is damaged. Because of convenience on instantly writing and manually binding, outwardly visible content and a low manufacturing cost, the paper-shaped non-volatile storage device is much more user-friendly than the traditional non-volatile storage devices and can be used as consumable items.

Therefore, the paper-shaped non-volatile storage device features as both of traditional paper sheets and traditional non-volatile storage devices, including but not limited to instantly writing, manually binding, and outwardly visible content as provided by the traditional paper sheets; digital information storage, repeatable editing and rapid search capability as provided by the traditional non-volatile storage devices.

### BRIEF DESCRIPTION OF THE DRAWINGS

The present invention may best be understood through the following description with reference to the accompanying drawings, in which:

FIG. 1 illustrates a stereographic view of a conventional Secure Digital (SD) card;

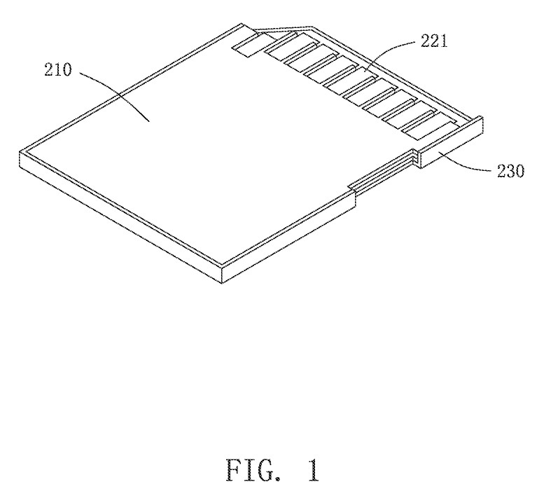

FIG. 2 is an exploded stereographic view of FIG. 1;

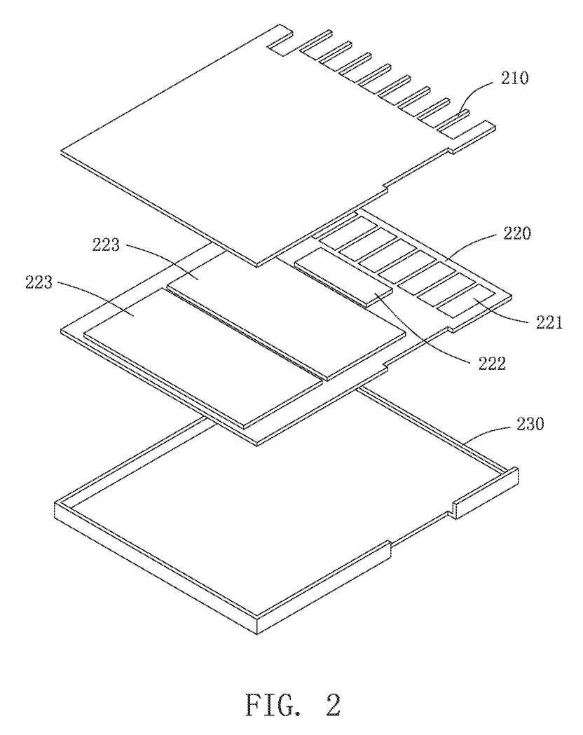

FIG. 3 is a stereographic view of a paper-shaped non-volatile storage device according to a preferred embodiment of the present invention;

FIG. 4 is an exploded stereographic view of FIG. 3; and

FIG. 5 is a stereographic view of the embodiment of the present invention, expressing lots of sheets of stacked paper-shaped non-volatile storage devices bound together, the cover of which is handwritten in words.

### DETAILED DESCRIPTION OF THE INVENTION

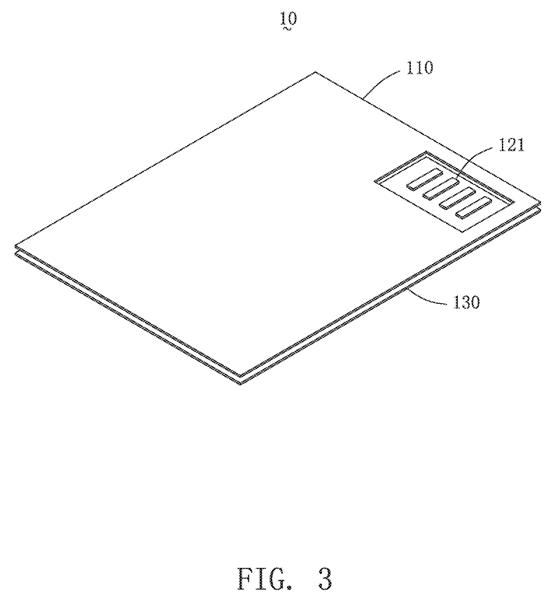

Firstly referring to FIGS. 3 to 5, a paper-shaped non-volatile storage device 10 in accordance with a preferred embodiment of the present invention is principally construed of a top paper layer 110, a bottom paper layer 130 and a flexible printed circuit board (PCB) 120 packaged between the top and the bottom paper layers 110, 130. The top paper layer 110 defines a through opening 112 (detailed later). The top and the bottom paper layers 110, 130 may be made of any kind of paper materials which can be handwritten thereon.

The flexible PCB 120 as a thin film having a predetermined thickness comprises a data-transmitting interface 121, a non-volatile memory controller 122 and at least one non-volatile memory 123 disposed thereon. The data-transmitting interface 121 functions as a serial port disposed with a plurality of conductive terminals on the flexible PCB 120, but can alternatively be one of a number of well known communication standards and protocols, e.g., a FireWire (IEEE 1394) interface, a Universal Serial Bus (USB), an infrared (IR) communication port, a Bluetooth wireless communication adapter, an Internet feed, and the like. The data-transmitting interface 121 is used to electrically connect with an external device (like a personal computer or a mobile phone) via an additional connector or cable, and thereby performing data transfer or reading/writing data from/to the paper-shaped non-volatile storage device 10. In this embedment, the paper-shaped non-volatile storage device 10 can be powered by the outside (e.g., the external device) via the data-transmitting interface 121. Both the non-volatile memory controller 122 and the non-volatile memory 123 are unpackaged in form of a bare die secured/adhered directly to the flexible PCB 120, without any outer hard case packaging and case molding process as formerly employed by traditional non-volatile memory devices. As the result, the paper-shaped non-volatile storage device 10 retains a flexibility or elasticity as the traditional paper sheets featuring. The non-volatile memory controller 122 complies with external instructions from the external device via the data-transmitting interface 121 to control the non-volatile memory 123 for performing data transmissions between the paper-shaped non-volatile storage device 10 and the external device. In practice, the non-volatile memory 123 may have a higher or lower memory capacity. In the embodiment, the non-volatile memory 123 contains a lower memory capacity so as to meet low expense and physical folder-collating requirements. Since the electrical connection of circuit layouts among the non-volatile memory controller 122, the data-transmitting interface 121 and the non-volatile memory 123 can be conventional, a detailed description thereof is omitted herein.

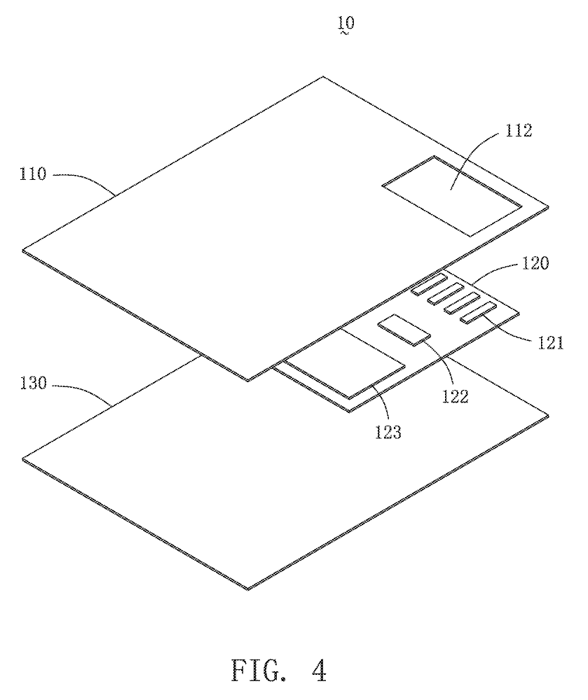

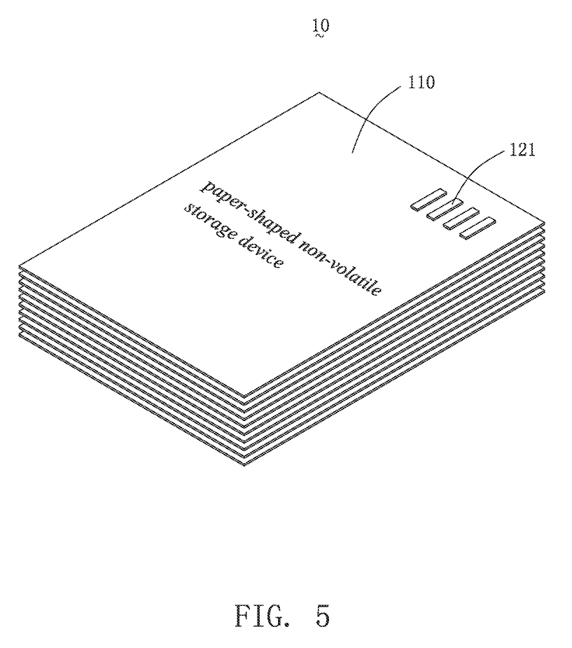

Referring to FIGS. 3 and 4, the top paper layer 110 bonds the bottom paper layer 130 together to package the flexible PCB 120 between the top and the bottom paper layers 110, 130 by laying of adhesive bonding material, a coating process or a pressing process etc. Under the situation, the opening 112 of the top paper layer 110 can expose the data-transmitting interface 121 (i.e., terminals) to the outside for convenience on electrically connecting with the external device or an end of a cable (not shown) and thereby transferring data between the paper-shaped non-volatile storage device 10 and the external device. On the other hand, the paper-shaped non-volatile storage device 10 still functions as provided by the traditional paper sheets, including but not limited instantly writing, printing and binding. In an exemplar shown in FIG. 5, a plurality of the paper-shaped non-volatile storage devices 10 are bound in sheets together, the cover of which is handwritten in words “paper-shaped non-volatile storage device.” Beside, digital information can be written/read in/from each sheet of the paper-shaped non-volatile storage device 10 through the data-transmitting interface 121 thereof, respectively.

In a second embodiment of the present invention, paper pulp materials (not shown) can be used to directly wrap around the flexible PCB 120 to integrally form the top paper layer 110 and the bottom paper layer 130. For example, the flexible PCB 120 is treated with a waterproof process and then is immersed in paper pulp materials. As the result, the paper pulp materials integrally form the top and bottom paper layer 110, 120 covering on opposite surfaces of the flexible PCB 120, thereby omitting a bonding step of the top paper layer 110 and the bottom paper layer 130. That is, the flexible PCB 120 is embedded in the integral formed top and bottom paper layers.

In a third embodiment of the present invention, the flexible PCB 120 is disposed with a paper layer on one of opposite surfaces of the board 120, and a coating layer is coated on the other surface to secure the flexible PCB 120 on the paper layer. The flexible PCB 120 is consequently packaged between the paper layer and the coating layer. The coating layer may be any chemical materials, which may provide a flexibility or elasticity as the traditional paper sheets have and can bond with the paper layer to the flexible PCB 120, including but not limited to adhesive layer, or chemical coating layer.

Comparing to the traditional paper sheets, the paper-shaped non-volatile storage device 10 is reusable to store digital information and the digital information is retrievable even if the paper-shaped non-volatile storage device 10 is damaged. Furthermore, because of convenience on instantly writing and manually binding, visible content and a low manufacturing cost, the paper-shaped non-volatile storage device 10 is much more user-friendly than the traditional non-volatile storage devices (i.e., memory cards) and can be treated as consumable items. Therefore, the paper-shaped non-volatile storage device 10 features as both traditional paper sheets and traditional non-volatile storage devices, including but not limited to instantly writing, manually binding and outwardly visible content as provided by the traditional paper sheets; digital information storage, repeatable editing and rapid search capability as provided by the traditional non-volatile storage devices. The present invention is particularly suited for great paper documents each of which needs to handwrite but carries lower memory capacity, for example, histories management in hospitals or students' performance in schools.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A paper-shaped non-volatile storage device comprising:
a top paper layer;
a bottom paper layer; and
a flexible printed circuit board packaged between the top and bottom paper layers, having a data-transmitting interface, a non-volatile memory controller and at least one non-volatile memory disposed on the board.

2. The paper-shaped non-volatile storage device of the claim 1, wherein the top paper layer bonds with the bottom paper layer to package the flexible printed circuit board therebetween.

3. The paper-shaped non-volatile storage device of the claim 1, wherein the top and bottom paper layers are integrally formed to wrap around two opposite surfaces of the flexible printed circuit board.

4. The paper-shaped non-volatile storage device of the claim 1, wherein the top paper layer defines an opening for exposing the data-transmitting interface to the outside.

5. The paper-shaped non-volatile storage device of the claim 1, wherein the non-volatile memory controller and the non-volatile memory both are made in form of bare die and secured to the flexible printed circuit board.

6. The paper-shaped non-volatile storage device of the claim 5, wherein the non-volatile memory controller, the data-transmitting interface and the non-volatile memory are electrically connected to each other.

7. The paper-shaped non-volatile storage device of the claim 5, wherein the non-volatile memory controller receives external instructions via the data-transmitting interface and controls the non-volatile memory according to the external instructions.

8. The paper-shaped non-volatile storage device of the claim 5, wherein the data-transmitting interface is a communication port compliant with any of communication standards and protocols and electrically connected to an external device for data transmission.

9. The paper-shaped non-volatile storage device of the claim 8, wherein the external device supplies power to the paper-shaped non-volatile storage device through the data-transmitting interface.

10. The paper-shaped non-volatile storage device of the claim 5, wherein the non-volatile memory has a low memory capacity.

11. A paper-shaped non-volatile storage device comprising:
at least one paper layer; and
a flexible printed circuit board, the at least one paper layer covering a surface of flexible printed circuit board having a data-transmitting interface, a non-volatile memory controller and at least one non-volatile memory disposed on the board.

12. The paper-shaped non-volatile storage device of the claim 11, wherein the non-volatile memory controller and the non-volatile memory both are made in form of bare die and secured to the flexible printed circuit board.

13. The paper-shaped non-volatile storage device of the claim 12, wherein the at least one paper layer defines an opening for exposing the data-transmitting interface to the outside.

14. The paper-shaped non-volatile storage device of the claim 12, wherein the non-volatile memory controller, the data-transmitting interface and the non-volatile memory are electrically connected to each other.

15. The paper-shaped non-volatile storage device of the claim 12, wherein the non-volatile memory controller receives external instructions via the data-transmitting interface and controls the non-volatile memory according to the external instructions.

16. The paper-shaped non-volatile storage device of the claim 12, further comprising a coating layer covering on an opposite surface of the flexible printed circuit board.

17. The paper-shaped non-volatile storage device of the claim 16, wherein the coating layer secures the flexible printed circuit board on the at least one paper layer.

18. The paper-shaped non-volatile storage device of the claim 17, wherein the coating layer provides a flexibility or elasticity as provided by a traditional paper sheet.
